(19) United States
(12) Patent Application Publication
(10) Pub. No.: US 2013/0149484 A1
(43) Pub. Date: Jun. 13, 2013

(54) PANELS WITH DECORATIVE OBJECTS AND METHODS OF MAKING THE SAME

(71) Applicant: 3form, Inc., Salt Lake City, UT (US)

(72) Inventors: Charles H. Moore, Salt Lake City, UT (US); Matthew T. Sutton, Salt Lake City, UT (US); John E. C. Willham, Sandy, UT (US); M. Hoyt Brewster, Salt Lake City, UT (US)

(73) Assignee: 3form, Inc., Salt Lake City, UT (US)

(21) Appl. No.: 13/707,959

(22) Filed: Dec. 7, 2012

Related U.S. Application Data
(60) Provisional application No. 61/568,366, filed on Dec. 8, 2011.

(51) Int. Cl. B29C 43/18

(52) U.S. Cl. CPC B29C 43/18
USPC 428/67; 264/271.1

(57) ABSTRACT

Implementations of the present invention relate to systems, methods, and apparatus for embedding objects within thermoplastic resin material and decorative thermoplastic panels resulting therefrom. Implementations include fusing thermoplastic resin particles together to form a decorative resin panel. Furthermore, a manufacturer can place decorative objects within the bed of thermoplastic resin particles to fabricate a decorative resin panel that encapsulates the decorative objects therein.

### CROSS-REFERENCE TO RELATED APPLICATIONS

The present application claims the benefit of priority to U.S. Provisional Patent Application No. 61/568,366, filed Dec. 8, 2011, entitled “Methods of Making Unitary Panels with Decorative Objects,” the entire content of which is incorporated herein by reference.

### BACKGROUND OF THE INVENTION

1. The Field of the Invention

This invention relates to apparatus, systems, and methods for fabricating resin panels with decorative objects and interlayers, which can have structural and/or aesthetic purposes.

2. Background and Relevant Art

Recent trends in building design involve adding to or changing the functional and/or aesthetic characteristics of a given structure or design space by mounting one or more decorative panels thereto. This is at least partly since there is sometimes more flexibility with how the panel (or set of panels) is designed, compared with the original structure. Panels formed from resin materials are particularly popular because they tend to be less expensive, in most applications, than materials such as glass or the like, where certain structural, optical, and aesthetic characteristics are desired.

In addition, resin materials tend to be more flexible in terms of manufacture and assembly because they can be relatively easily bent, molded, colored, shaped, cut, and otherwise modified in a variety of different ways. Decorative resins can also provide more flexibility compared with glass and other conventional materials at least in terms of color, degree of texture, gauge, and impact resistance. Additionally, decorative resins have a fairly wide utility since they may be formed to include a large variety of colors, images, interlayers, and shapes.

Along these lines, manufacturers commonly fabricate decorative resin panels by embedding objects between extruded sheets of resin material. To embed three-dimensional objects within the resin sheets, manufacturers typically melt two or more resin sheets around the decorative objects using a combination of pressure and heat. The final product therefore typically comprises two viewable surfaces through which the decorative objects are viewable. Manufacturers primarily embed substantially thin or flat decorative objects, such as flattened leaves, ferns, papers, cutout designs, fabrics, and so forth within resin panels, due to manufacturing complications that can arise when embedding thicker decorative objects. Thus, a manufacturer's design choices are typically limited to substantially two-dimensional (i.e., flat or thin) decorative objects.

One manufacturing complication that can arise when embedding thicker decorative objects is a difficulty in obtaining flat and uniform viewable surfaces on the resin panel. Particularly, in some instances, as the resin sheets melt around thicker objects, the molten material fills gaps between the objects, leaving visible surface bulging or bowing around the objects. Another manufacturing complication that can arise when embedding thicker objects is the crushing and/or flattening of the decorative objects during the pressing process, particularly when the objects are soft or brittle. Manufacturers have attempted to address these problems at one level or another through a multi-step heating and pressing process, which can lead to increased manufacturing cost and time.

Accordingly, there are a number of disadvantages in manufacturing resin panels with an interlayer that can be addressed.

### BRIEF SUMMARY OF THE INVENTION

Implementations of the present invention overcome one of the foregoing or other problems in the art with systems, methods, and apparatus for embedding objects within thermoplastic resin material to form decorative resin panels. Specifically, one or more implementations comprise a process for creating thermoplastic resin panels that involves providing a plurality of thermoplastic resin particles with one or more decorative objects positioned therein. Such implementations also involve applying heat and pressure to fuse the thermoplastic resin particles about the decorative objects. One or more implementations of the present invention thereby allow the manufacturing of thermoplastic panels that can incorporate fragile, hollow, compressible, or brittle objects without damaging or degrading the objects.

At least one implementation includes a method of manufacturing a decorative thermoplastic panel that incorporates decorative objects. Particularly, the method involves laying out a bed of thermoplastic resin particles and placing at least one decorative object at least partially within the bed of thermoplastic resin particles. Additionally, the method includes applying pressure to the bed of thermoplastic resin particles containing the at least one decorative object. Furthermore, the method includes applying heat to the bed of thermoplastic resin particles containing the at least one decorative object, thereby fusing the thermoplastic resin particles together about the at least one decorative object.

One or more implementations include at least one other method of manufacturing a decorative thermoplastic panel that incorporates decorative objects. More specifically, such method includes laying out a bed of thermoplastic resin particles having a first dimension defined by a length thereof, a second dimension defined by a width thereof, and a third dimension defined by a thickness thereof. The first, second, and third dimensions define a plurality of two-dimensional planes. The method also includes placing at least one flexible decorative object within the bed of thermoplastic resin particles in a manner that at least a portion of the at least one flexible decorative object is in two or more two-dimensional planes of the plurality of two-dimensional planes. Moreover, the bed of thermoplastic resin particles together with the at least one flexible decorative object form a layup assembly. The method also includes applying pressure to the layup assembly and applying heat to the layup assembly, thereby fusing the thermoplastic resin particles together about the at least one flexible decorative object.

Additional or alternative implementations of the present invention include a decorative thermoplastic resin panel with a sheet-like three-dimensional decorative interlayer. For instance, such decorative thermoplastic resin panel has a fused thermoplastic block having a first dimension defined by a length thereof, a second dimension defined by a width thereof, and a third dimension defined by a thickness thereof. The first, second, and third dimensions define a plurality of two-dimensional planes. Additionally, the thermoplastic resin panel incorporates at least one flexible decorative object that is encapsulated within the fused thermoplastic block. Furthermore, at least a portion of the at least one flexible decorative object is positioned in two or more two-dimensional planes of the plurality of two-dimensional planes.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective view of a layup assembly including thermoplastic resin particles surrounding the decorative objects and filing the containment cell in accordance with one implementation of the present invention;

FIG. 2 illustrates a perspective view of a plurality of thermoplastic resin particles and one or more decorative objects within the containment cell of FIG. 1;

FIG. 3 illustrates cross-sectional view of the layup assembly of Figure 1;

FIG. 4 illustrates a cross-sectional view of the layup assembly of FIG. 3 between the platens of a press in accordance with one implementation of the present invention;

FIG. 5 illustrates a perspective view of a thermoplastic panel with embedded decorative objects formed from the panel layup assembly of FIG. 3 in accordance with one implementation of the present invention;

FIG. 6A illustrates a cross-sectional view of another layup assembly and a schematic representation of heat and pressure applied thereto in accordance with another implementation of the present invention;

FIG. 6B illustrates a perspective view of a thermoplastic panel with an embedded decorative object formed from the layup assembly of FIG. 6B in accordance with another implementation of the present invention;

FIG. 6C illustrates a perspective view of a thermoplastic panel with embedded decorative objects in accordance with yet another implementation of the present invention;

FIG. 7A illustrates a cross-sectional view of a yet another layup assembly and a schematic representation of heat and pressure applied thereto in accordance with still another implementation of the present invention;

FIG. 7B illustrates a perspective view of a thermoplastic panel with embedded decorative objects formed from the layup assembly of FIG. 7A in accordance an implementation of the present invention;

FIG. 8A illustrates a cross-sectional view of another layup assembly and a schematic representation of heat and pressure applied thereto in accordance with one or more implementations of the present invention;

FIG. 8B illustrates a multilayer thermoplastic panel with embedded objects formed from the layup assembly of FIG. 8A in accordance with one implementation of the present invention;

FIG. 9 illustrates a chart of acts in a method of fabricating a thermoplastic panel with embedded decorative objects in accordance with one implementation of the present invention; and

FIG. 10 illustrates a chart of acts and steps in of a method of fabricating thermoplastic panel with embedded decorative objects in accordance with another implementation of the present invention.

### DETAILED DESCRIPTION OF THE PREFERRED EMBODIMENTS

Implementations of the present invention comprise systems, methods, and apparatus for embedding objects within thermoplastic resin material to form decorative resin panels. Specifically, one or more implementations comprise a process for creating thermoplastic resin panels that involves providing a plurality of thermoplastic resin particles with one or more decorative objects positioned therein. Such implementations also involve applying heat and pressure to fuse the thermoplastic resin particles about the decorative objects. One or more implementations of the present invention thereby allow the manufacturing of thermoplastic panels that can incorporate fragile, hollow, compressible, or brittle objects without damaging or degrading the objects.

More particularly, a process of fabricating thermoplastic resin panels can involve forming (or laying out) one or more layers of thermoplastic resin particles and positioning decorative objects therein. Such implementations also involve applying heat and pressure to at least partially melt and fuse the thermoplastic resin particles together. Moreover, to the extent that the thermoplastic resin particles have decorative objects embedded therein, the thermoplastic resin particles can fuse together about the decorative objects, thereby encapsulating the decorative objects within a fused thermoplastic panel.

The use of thermoplastic resin particles can allow decorative objects of essentially any shape and/or physical characteristics to be embedded within a thermoplastic panel. For instance, the manufacturer can place hollow decorative objects within a plurality of thermoplastic resin particles. As such, the thermoplastic resin particles can fill voids, cavities, or otherwise empty spaces within the hollow decorative objects. As a result the hollow decorative objects are reinforced when subjected to heat and pressure. Consequently, the thermoplastic resin particles within the cavities and around the hollow decorative objects can fuse together, thereby encapsulating the hollow decorative objects.

Additionally, because the manufacturer can place the decorative objects within the plurality of thermoplastic resin particles, the decorative objects do not have to displace any material. As a result, the manufacturing process may require less pressure as compared with embedding decorative objects between thermoplastic resin sheets. Thus, one or more implementations of the present invention can allow the manufacturing of thermoplastic panels to incorporate compressible, brittle, or otherwise fragile decorative objects without damaging or degrading such decorative objects.

As explained in greater detail below, the resin particles can allow placement of decorative objects at essentially any location within a block or bed of thermoplastic resin particles. Hence, implementations of the present invention may include panels with decorative objects disposed along various planes and/or axes within the panel. In other words, the decorative objects do not have to align along a single plane (as typical with panels formed using resin sheets).

In one or more implementations, adding the decorative objects may result in an increased aesthetic appeal of the thermoplastic panel. Additionally or alternatively, including the decorative objects in the thermoplastic panel may also result in increased structural strength, elimination of delamination associated with the use of thermoplastic film or sheet substrates, as well as improving the impact resistance of the thermoplastic panel. Accordingly, the embedded decorative objects can increase both the aesthetic appeal as well as improve physical properties of the thermoplastic panel.

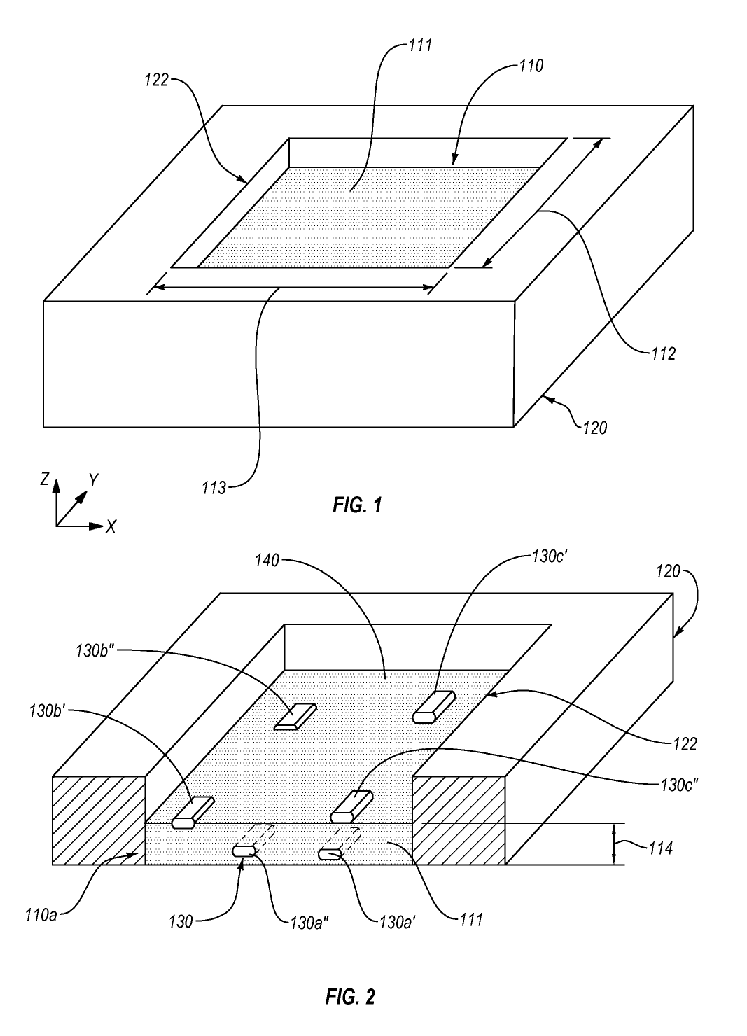

For better understanding, certain aspects or features described in the disclosure may be identified by referring to a direction or dimension along X, Y, and/or Z axes, which are defined by the coordinate system shown in FIG. 1. When a reference is made to a two-dimensional plane, such as an X-Y, Y-Z, or X-Z plane, it shall be understood to refer to a plane defined by the referenced axes. The same coordinate system as well as reference axes and planes are applicable to all Figures.

FIGS. 1 through 4 illustrate one or more implementations of a method for making a thermoplastic panel with one or more decorative objects embedded therein. As used herein, the term “decorative” object shall mean any object that may be implanted into a thermoplastic resin panel. A decorative object may serve purely aesthetic, purely structural, or a combination of aesthetic and structural functions within the thermoplastic panel. Furthermore, a decorative object may be three- or substantially two-dimensional. Examples, of substantially two-dimensional objects include, but are not limited to, films, fabrics, and other sheet-like decorative objects.

Moreover, decorative objects may comprise any organic and inorganic materials. In addition, “decorative objects” comprises any organic or inorganic materials that can be construed as compressible objects, i.e., objects that may deform (split, crack, or flatten) under pressure. For the purposes of this specification and claims, organic materials will be understood to comprise any natural or synthetic decorative materials, such as thatch, bamboo, tree or bush branches or stems, willow reed, leaves, beans (e.g., coffee beans), and so forth.

The foregoing list of exemplar decorative objects and materials thereof, however, is not intended to be exhaustive, but merely illustrative of the type of materials that can be used in accordance with the present invention, and that otherwise would not be suitable for use in conventional thermosetting processes. Similarly, inorganic materials, by contrast, can comprise any natural or synthetic items, such as rock, glass, other types of minerals, metals and so forth. Such inorganic items ordinarily may be bent or crushed, so that the final decorative product does not exceed a desired thickness, or thinness, and to make sure the final panel has a smooth, uniform surface. The thickness of either organic or inorganic materials can be between approximately 0.05 and approximately 2 inches.

As noted above, implementations of the present invention can include a plurality of thermoplastic resin particles formed into a bed or block. For example, FIG. 1 illustrates a perspective view of a bed or block 110 of thermoplastic resin particles 111. As used herein, the term “resin” refers to any one of the following thermoplastic polymers (or alloys or combinations thereof). Specifically, such materials can include, but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), polylactic acid (PLA), polyhydroxyalkanoate (PHA), or the like.

It should also be noted that, as used herein, the terms “bed,” “block,” and “layer” of thermoplastic resin particles refers to any arrangement of thermoplastic resin particles, which collectively may have a thickness, a width, and a length that define outer dimensions of such bed, block, or layer. The thickness, width, length, and any combination thereof of a layer can be constant or variable across the bed, block, or layer and can vary from one implementation to another. Also, the bed, block, or layer can be continuous or interrupted. A single layer or multiple layers can form a bed or block of thermoplastic resin particles, as further described below.

As shown by FIG. 1, the bed or block 110 of thermoplastic resin particles 111 can have a width 112 and a length 113. The bed or block 110 of thermoplastic resin particles 111 can also include a thickness. As explained in greater detail below, a manufacturer can form the bed or block 110 of thermoplastic resin particles 111 a layer at a time. This can allow the manufacturer to place decorative objects at different heights or positions with the bed or block 110 of thermoplastic resin particles 111.

Referring now to FIG. 2, the bed or block 110 of thermoplastic resin particles 111 can include a first layer 110a. The first layer can have a thickness 114. The thickness 114 may be uniform throughout the first layer 110a of thermoplastic resin particles 111. Additionally, the thickness 114 can comprise approximately 0.13″ to 2.00″ (3.2 mm to 51 mm), approximately 0.13″ to 1.00″ (3.2 mm to 25 mm), or approximately 0.13″ to 0.500″ (3.2 mm to 13 mm).

One will appreciate in light of the disclosure herein that the layer or layers that form the bed or block 110 of thermoplastic resin particles 111 can vary from one implementation to the next. For example, the layers 110a can be thicker than 2.00″ or thinner than 0.13″. Furthermore, the manufacturer can form the first layer 110a with the thickness that is non-uniform. Particularly, the thickness of the first layer 110a can vary along the width 112 and/or the length 113. Likewise, dimension of the bed or block 110 of thermoplastic resin particles 111 also can be uniform or can vary along any one or more of the width 112, length 113, and thickness.

In one or more implementations, the manufacturer can form the first layer 110a in a containment cell 120. Particularly, the containment cell 120 can surround the first layer 110a (as well as the bed or block 110 of thermoplastic resin particles 111, as further described below) and can restrain the thermoplastic resin particles 111 from dispersing about a support surface. In other words, the containment cell 120 can allow the manufacturer to form the first layer 110a, which has a perimeter (i.e., an outer shape) defined by a containment window 122.

Particular dimensions and shape of the containment window 122 can vary from one implementation to the next. In at least one implementation, the containment window 122 can have a substantially rectangular shape to produce a substantially rectangular thermoplastic panel, as further described below. Alternatively, however, the containment window can have any number of suitable shapes and sizes. For instance, the containment window 122 can have one or more rounded portions, irregular portions, straight portions, and any combination thereof, which collectively can define the shape and size of the containment window 122.

Furthermore, the containment window 122 of the containment cell 120 can have a suitable depth to accommodate one or more layers of thermoplastic resin particles 111. In other words, the depth of the containment window 122 can be equal to or greater than the thickness of the first layer 110a as well as of any subsequent layers, which form the bed or block 110 of the plastic resin particles 111. Moreover, the containment window 122 can pass entirely through the containment cell 120. Alternatively, the containment window 122 can be a blind window, such that a portion of the containment cell 120 forms the bottom of the containment window 122.

The manufacturer can apply pressure and heat to the containment cell 120 together with the bed of thermoplastic resin particles 111, to form the thermoplastic panel. Additionally, in at least one implementation, the containment cell 120 can comprise flexible material that can deform in response to the applied pressure. Hence, for example, a platen of a press can compress the bed or block 110 of thermoplastic resin particles 111 together with the containment cell 120. Alternatively, the containment cell 120 can comprise substantially incompressible material, such as steel, as described below in more detail.

At least one implementation may include utilizing thermoplastic resin particles 111 of various shapes and sizes. Such thermoplastic resin particles 111 can have a single surface or a plurality of surfaces. For example, thermoplastic resin particles 111 may have a substantially spherical shape, such as granules, pellets, or powders. Other examples include thermoplastic resin particles 111 that have a substantially flat and/or flake-like shapes or irregular three-dimensional shapes.

The thermoplastic resin particles 111 may have at least one dimension of approximately 0.10″ (2.5 mm). Additionally or alternatively, the manufacturer can use the thermoplastic resin particles 111 that have at least one dimension of approximately 0.01″ (0.25 mm). For instance, when the thermoplastic resin particles 111 have a substantially spherical shape and a diameter of approximately 0.01″, the thermoplastic resin particles 111 may comprise a relatively coarse powder.

The number of thermoplastic resin particles 111 in a particular bed or block 110 can depend upon the size of the bed or block 110 and the size of the thermoplastic resin particles 111. In any event, a bed or block 110 of thermoplastic resin particles 111 can include hundreds, thousands, or even tens of thousands of thermoplastic resin particles 111.

The first layer 110a may be substantially uniform with respect to the size and/or shape of the thermoplastic resin particles 111. For example, the first layer 110a may comprise thermoplastic resin particles 111 substantially all of which have the same or similar size and shape (e.g., as granules of a virgin thermoplastic material). In one or more additional or alternative implementations, the first layer 110a may include thermoplastic resin particles 111 of varying shapes and/or sizes. For example, the thermoplastic resin particles 111 may be formed by regrinding thermoplastic material and may have irregular shapes and/or variable sizes. Furthermore, the first layer 110a may comprise thermoplastic resin particles 111 from a mix of virgin and reground thermoplastic materials, which may have respective granular and irregular shapes and varying sizes.

As described above, thermoplastic resin particles 111 can comprise a number of thermoplastic resin materials. One or more implementations also may include thermoplastic resin particles 111 that can comprise a single type of thermoplastic material. Additionally or alternatively, the thermoplastic resin particles 111 can comprise homogeneously or non-homogeneously mixed multiple, different types of thermoplastic materials. Hence, the thermoplastic resin particles 111 can have the same, similar, or distinct properties with respect to thermoplastic resin type, shape, and/or size. In any event, the manufacturer can use any number of combinations of suitable thermoplastic particles 111, which can vary from one implementation to the other.

As described above, the bed or block 110 of thermoplastic resin particles 111 can contain one or more decorative objects. For example, as illustrated in FIG. 2, the manufacturer can position multiple decorative objects 130 (e.g., decorative object 130a′, 130a″, 130b′, 130b″, 130c′, 130c″) on or within the first layer 110a. For instance, the decorative objects 130a′, 130a″ can be embedded entirely within the first layer 110a. By contrast, decorative objects 130b′, 130b″ can be only partially embedded within the first layer 110a. Furthermore, the manufacturer can position the decorative objects 130c′, 130c″ on top of the first layer 110a.

In at least one implementation, the decorative objects 130 may be disposed substantially along the same X-Y plane at a desired position along the Z axis, on or within the first layer 110a. For example, the manufacturer can position the decorative objects 130a′, 130a″ along the same X-Y plane (e.g., center points of the decorative objects 130a′, 130a″ can be located at the same depth from a top surface 140 of the first layer 110a). Additionally or alternatively, a single or multiple decorative objects 130 may be disposed along multiple X-Y planes at various positions along the Z axis, on or within the first layer 110a.

In any event, the manufacturer can position the decorative objects 130 along the Z axis in a manner that a predetermined number of decorative objects 130 are disposed along any one X-Y plane. The manufacturer also can position decorative objects 130 randomly, uniformly, or in a predictable pattern anywhere within the first layer 110a. The freedom to position the decorative objects 130 at any location within the first layer 110a as well as within any subsequent layer and/or generally anywhere within the bed or block 110 allows production of various panels that can embody numerous aesthetic and/or three-dimensional displays.

As described above, the manufacturer may form the first layer 110a with uniform thickness 114. In at least one implementation, however, the method may include forming the first layer 110a, which has the thickness 114 that may vary along the width 112 and/or the length 113. Hence, the manufacturer can form the first layer 110a with a substantially flat top surface 140. Additional or alternative implementations also may include forming the first layer 110a with the top surface 140 that may have a curved shape or irregular formations thereon.

As noted above, the manufacturer can place decorative objects 130 along the top surface 140 of the first layer 110a. Thus, in some instances, the decorative objects 130 may be disposed along a substantially flat top surface 140 and may lie substantially in the same X-Y plane. For example, the decorative objects 130b′, 130b″ can lie along the same X-Y plane in a manner that top surfaces of the decorative objects 130b′, 130b″ are elevated to the same distance above the top surface 140 of the first layer 110a. Likewise, the decorative objects 130c′, 130c″ can lie on top of the flat top surface 140, which can define another X-Y plane (i.e., bottom surfaces of the decorative objects 130c′, 130c″ can lie in the same X-Y plane, formed by the top surface 140).

Those skilled in the art should appreciate that this disclosure is not limited to locating the decorative objects 130 within the same flat (or two-dimensional) X-Y plane formed by the top surface 140. For instance, a manufacturer can position the decorative objects 130 along a curved or irregular top surface 140. Consequently, the decorative objects 130 can lie along a curved plane defined by the top surface 140. Furthermore, the layup assembly may include one or more flexible decorative objects 130 that substantially conform to the contour of the top surface. As further described below, examples of the decorative objects 130 can include, but are not limited to, fabric, film, or similar material that can be laid over the top surface 140.

Implementations of the present invention may include decorative objects 130 that have three-dimensional or substantially two-dimensional shapes. Examples, of substantially two-dimensional objects include but are not limited to film, foil, fabric, netting, and leaves. Examples of three-dimensional objects include but are not limited to twigs, bamboo, stones, and beans. Moreover, in at least one implementation, three-dimensional objects can be hollow and/or cored out. Examples of hollow and/or cored out objects include but are not limited to shells and honeycomb structures.

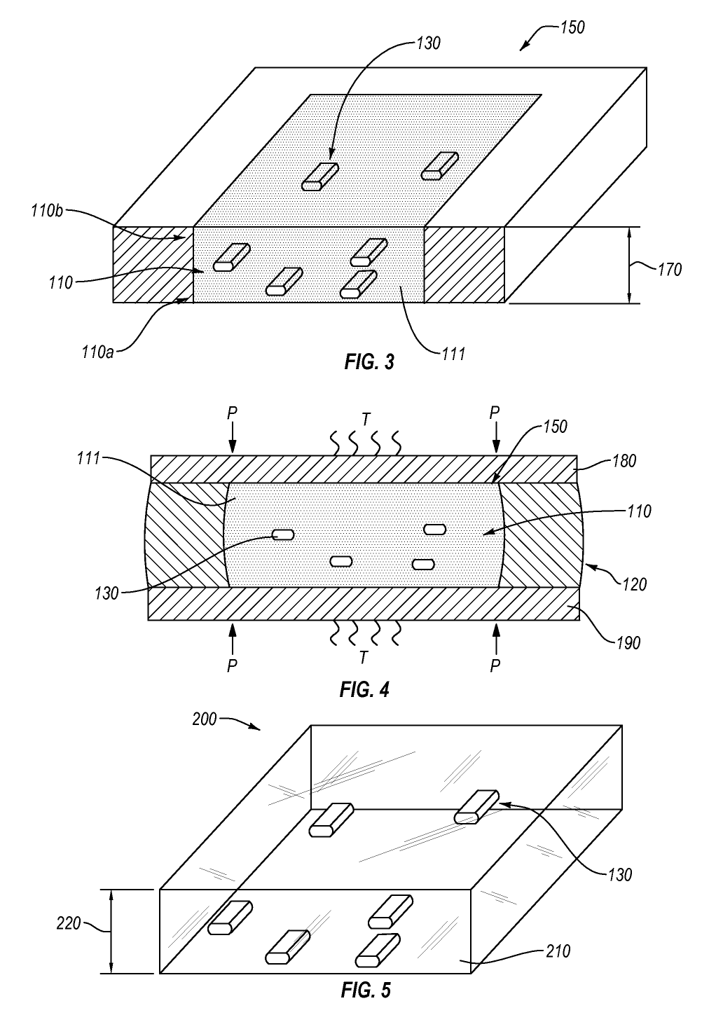

Once the manufacturer positions the decorative objects 130 within the first layer 110a and/or along the top surface 140, additional layers or amounts of thermoplastic resin particles 111 may be added to the first layer 110a to form the block or bed 110 for further processing. More specifically, as illustrated in FIG. 3, a layup assembly 150 can comprise a bed or block 110 of thermoplastic resin particles 111, which can surround the decorative objects 130.

In particular, the bed or block 110 of thermoplastic resin particles 111 can comprise a second layer 110b of thermoplastic resin particles 111 on top of the first layer 110a. Additionally or alternatively, the bed or block 110 of thermoplastic resin particles 111 may also include any number of additional layers of thermoplastic resin particles 111. The bed or block 110 of thermoplastic resin particles 111 may have an overall thickness 170. In at least one implementation, the first layer 110a and the second layer 110b that form the bed or block 110 of thermoplastic resin particles 111 may have similar thicknesses. Furthermore, the thermoplastic resin particles 111 also can comprise pigment additives and/or colored thermoplastic particles.

It should be appreciated that the thickness 170 as well as the length and width of the bed or block 110 of thermoplastic resin particles 111 are used for ease of descriptions and are not intended to be limiting in any way. Accordingly, any one of the dimensions of the bed or block 110 of thermoplastic resin particles 111 (i.e., thickness 170, length, and width) can be equal to, greater than, or smaller than any other dimension.

The manufacturer can form the layup assembly 150 in any number of ways that can vary from one implementation to the other. The bed or block 110 of thermoplastic resin particles 111 can have a single or multiple layers. Furthermore, the bed or block 110 of thermoplastic resin particles 111 can comprise a desirable quantity of thermoplastic resin particles 111 arranged in close proximity to one another. As noted above, for instance, the manufacturer can arrange the thermoplastic resin particles 111 in close proximity by depositing the thermoplastic resin particles 111 within the containment window 122 of the containment cell 120.

Furthermore, the manufacturer can embed or place the decorative objects 130 within the bed or block 110 of thermoplastic resin particles 111 by utilizing any number of suitable sequences of operations or acts. For instance, the manufacturer can position decorative objects 130 by initially providing an amount of thermoplastic resin particles 111 (e.g., forming the first layer 110), subsequently placing the decorative objects 130 on or into the thermoplastic resin particles 111, and adding further amounts of thermoplastic resin particles 111. In another example, the manufacturer can form the bed or block 110 of thermoplastic resin particles 111 and, subsequently, place the decorative objects 130 within the bed or block 110. In any event, however, the layup assembly 150 can comprise the bed or block 110 of thermoplastic resin particles 111 with decorative objects 130 positioned on or therein.

In some instances, the manufacturer may desire to produce a finished thermoplastic panel that has a predetermined and/or desired thickness. Thus, relative post-processing shrinkage of the thermoplastic resin particles 111 may be taken into account when determining a desirable thickness 170 of the bed or block 110 of thermoplastic resin particles 111. In some instances, for example, a three-percent shrinkage may be calculated into the thickness 170.

As mentioned above, in one or more implementations, a method may include applying pressure and heat to the layup assembly 150. For example, as illustrated in FIG. 4, a temperature T of between about 180° F. and about 350° F. may be utilized to melt and/or fuse the thermoplastic resin particles 111 into a fused thermoplastic panel, which can encapsulate the decorative objects 130. Thus, as the thermoplastic resin particles 111 melt and fuse together and about the decorative objects 130, the thermoplastic resin particles 111 can form a thermoplastic panel with embedded decorative objects 130.

The optimal temperature T for melting and fusing the thermoplastic resin particles 111 may vary depending on various factors including, but not limited to the thickness 170, the type of material of the thermoplastic resin particles 111, and the processing P. The optimal temperature may also vary depending on the thickness, shape, and durability of the decorative objects 130. It should be appreciated that the previously described temperatures provide only approximate values within a range of approximately ±15° to 20° F. As such, the manufacturer need not ensure that the temperatures and pressures of a given process reach the previously described pressures and temperatures exactly. In particular, the manufacturer only needs to ensure that the temperatures and pressures of a given process are in a suitable range for softening, melting, and fusing the thermoplastic resin particles 111 into the fused thermoplastic panel.

The method also can include applying a processing pressure P that can be between approximately 5 pounds per square inch (psi) and approximately 250 psi, and preferably between about 5 psi and about 150 psi. Thus, the manufacturer can hold the bed or block 110 of thermoplastic resin particles 111 at an appropriate temperature and pressure for a period of time, to at least partially melt and fuse the thermoplastic resin particles 111 together. Such period can be between about 0.1 minutes and 60 minutes.

It should be noted that the appropriate pressure P may vary depending on the material of the thermoplastic resin used in the process as well as on the type or types of decorative objects 130. For instance, the decorative objects 130 may be soft, brittle, or otherwise fragile and susceptible to damage, deformation, or breakage during the application of pressure to the layup assembly 150. Thus, one or more decorative objects 130 positioned within the bed or block 110 of thermoplastic resin particles 111 can have a critical breaking point at a certain pressure, which can deform, misshape, damage, or break the decorative objects 130. In one example, the critical breaking point for one or more of the decorative objects 130 can be about 50 psi, 75 psi, or about 90 psi, depending upon the particular decorative object 130.

In at least one implementation, the thermoplastic resin particles 111 may move and/or slip past each other during the application of pressure. The movement and/or slippage of thermoplastic resin particles 111 with respect to each other may reduce the effective pressure on one or more of the decorative objects 130. Hence, the fragile decorative objects 130, with relatively low critical breaking points, can be positioned within the bed or block 110 of thermoplastic resin particles 111 of the layup assembly 150, which will be exposed to pressures above the critical breaking point of the decorative objects 130, without deforming, damaging, or breaking the decorative objects 130.

Generally, the method may comprise using a heated mechanical press, autoclave, or other thermosetting environment. Heated mechanical press for performing various acts of the methods described herein include but are not limited to hot steam, electric heat, hot oil heated, and other methods. In light of this disclosure, one will appreciate that the temperatures and pressures for laminating with a heated mechanical press, autoclave, or other thermosetting environment can depend on the material type of the thermoplastic resin particles 111.

Additionally, the process of fabricating the thermoplastic panel, using one or more implementations of the method described herein, can be performed either with or without a vacuum press. The trapped air or air bubbles in the thermoplastic panel are less likely to occur if the air is evacuated prior to or during the process. As a result of pressure and heat, the thermoplastic resin particles 111 are fused together and the decorative objects 130 are encased in the fused thermoplastic block that forms the thermoplastic panel with decorative objects 130.

In one or more implementations, plates (or platens) 180, 190 of a press can compress the layup assembly 150 (i.e., can apply pressure P to the bed or block 110 of thermoplastic resin particles 111). Also, as mentioned above, the containment cell 120 can be at least partially flexible. Hence, the plates 180, 190 can compress the containment cell 120 together with the layup assembly 150. Additionally or alternatively, the containment cell 120 can incorporate a bottom portions and/or the plate 190, which can contain the layup assembly 150 within the containment cell 120.

As noted above, however, the containment cell 120 also can be rigid, such that, for instance, the plate 180 may fit inside the containment window and compress bed or block 110 of thermoplastic resin particles 111. In any event, the manufacturer can apply pressure to the layup assembly 150 (e.g., by compressing the layup assembly between the plates 180, 190). Furthermore, in at least one implementation, the plate 180 and/or the plate 190 can be substantially flat. Consequently, the flat plates 180, 190 can form the thermoplastic panel that has substantially flat opposing surfaces.

It should be appreciated, however, that this invention is not limited to forming thermoplastic panels that have substantially flat surfaces. Particularly, the plate 180 and/or the plate 190 can have non-flat profiles. For instance, the plate 180 and/or the plate 190 can have bent profiles, curved profiles, irregularly shaped profiles, and combinations thereof. Accordingly, the corresponding surfaces of the thermoplastic panel formed by the respective plates 180, 190 can take a profile of such plates.

Furthermore, the method may include using dimpled, textured or other configurations of plates or molds (or intervening sheets) to apply a texture to the thermoplastic resin particles 111. Hence, in one or more implementations, the method may be used to make fused thermoplastic panels that can be curved or may have curvilinear surfaces prior to cooling. Moreover, the plates or molds used to compress, melt, and fuse the thermoplastic resin particles 111 may have various formations, such as dimples, cutouts, voids or cavities, textured segments, or other shapes, which may be transferred to a formed surface of the thermoplastic panel.

In addition, or as an alternative to using a mechanical press to fabricate the thermoplastic panel, the manufacturer can place the layup assembly 150 into an autoclave, which can apply pressure and heat to the layup assembly 150. Hence, the autoclave can heat, press, and fuse together the thermoplastic resin particles 111 and form the fused thermoplastic panel that encapsulates the decorative objects 130 (i.e., the thermoplastic panel with decorative objects 130). As such, the manufacturer can place the layup assembly 150 into a containment cell 120 (either rigid, flexible, or a combination thereof) and can avoid compressing the bed or block 110 of thermoplastic resin particles 111 of the thermoplastic resin particles with the plate 180.

It should also be appreciated that each of the thermoplastic resin particles 111 can include a plurality of surfaces that can be in contact with other thermoplastic resin particles 111 and/or with one or more of the decorative objects 130. In at least one instance, when pressure and heat are applied to the layup assembly 150, the plurality of surfaces of the thermoplastic particles 111 that are in contact with each other may fuse together. Furthermore, under heat and pressure, the plurality of surfaces of the thermoplastic particles 111 in contact with the one or more decorative objects 130 may fuse to or about the decorative objects 130. This is in contrast to conventional methods of making thermoplastic panels with decorative objects in which only a single surface of a thermoplastic sheet is bonded and/or laminated to other surfaces or objects.

Following the heating, pressing, at least partially melting, and fusing together the thermoplastic resin particles 111, the formed thermoplastic panel can be allowed to cool below the glass transition temperature of the particular thermoplastic resin material. For instance, the manufacturer can rigidly hold the thermoplastic panel at a temperature of about 50° F. to about 120° F. and at a pressure of about 1 to about 120 psi, until the resin material cools below the glass transition temperature to form a panel 200 as shown by FIG. 5.

By holding the thermoplastic panel 200 rigidly in a fixed position during the cooling process, the thermoplastic panel 200 may retain a desired shape after it has cooled. For example, in one or more implementations, during the cooling process, the manufacturer can hold the thermoplastic panel substantially flat, and after cooling, the thermoplastic panel 200 may maintain such flat shape. Alternatively, the thermoplastic panel 200 may be bent or shaped to hold essentially any desired shape (e.g., an arcuate shape) during the cooling process, and after the cooling process the thermoplastic sheet may maintain such shape.

The manufacturer also can remove the thermoplastic panel 200 (e.g., from the press, autoclave, or other forming apparatus) before the thermoplastic panel cools below the glass transition temperature. Accordingly, the thermoplastic panel 200 can remain at least partially pliable, which can allow the manufacturer to bend and shape the thermoplastic panel to a desired shape and/or configuration. Subsequently, the manufacturer can allow the thermoplastic panel to cool below the glass transition temperature thereby retaining the desired shape produced by bending and shaping of the thermoplastic panel while the thermoplastic panel was in a pliable state.

In any event, by heating, pressing, and fusing together the thermoplastic resin particles 111 about the decorative objects 130, the manufacturer can produce the thermoplastic panel 200. An exemplary thermoplastic panel 200 is illustrated in FIG. 5. For instance, the thermoplastic panel 200 can comprise fused thermoplastic resin material 210 that encapsulates the decorative objects 130. Depending on the particular thermoplastic material(s) that comprise the thermoplastic resin particles, the fused resin material 210 can have various optical properties. For instance, the fused thermoplastic resin material 210 can be substantially transparent, such that the decorative objects 130 can be visible within the thermoplastic panel 200. Alternatively, at least a portion of the thermoplastic resin material 210 can be semi-transparent or substantially opaque, such as to conceal some or a portion of the decorative objects 130.

In one or more implementations, the fused thermoplastic resin material 210 can have a substantially rectangular shape. As described above, however, the fused thermoplastic resin material 210 can have essentially any suitable shape, which can be defined, for example, by the containment window of the containment cell and/or by the plates compressing the layup assembly. Additionally, the outside dimensions of the fused thermoplastic resin material 210 can define the outside dimensions of the thermoplastic panel 200. For instance, the thermoplastic panel 200 may have a thickness 220, which may have a first range of approximately 0.13″ to 2.00″ (3.2 mm to 51 mm), a second range of approximately 0.13″ to 1.00″ (3.2 mm to 25 mm), and a third range of approximately 0.13″ to 0.500″ (3.2 mm to 13 mm). Additionally or alternatively, in one or more implementations the method may be used to form the thermoplastic panel 200 that has the non-uniform thickness 220, which may vary along the X and/or Y axes. Moreover, in some implementation, the thermoplastic panel 200 may be thicker than 2.00″ or thinner than 0.13″.

In at least one implementation, the thermoplastic panel 200 can incorporate substantially rigid decorative objects 130 encased within the fused thermoplastic resin material 210. Moreover, as noted above, the thermoplastic panel 200 can have decorative objects 130 positioned within the fused thermoplastic resin material 210 in essentially any manner, including but not limited to random and ordered or patterned configurations. Furthermore, the manufacturer can encapsulate the decorative objects 130 within the fused thermoplastic resin material 210 at predetermined positions. For example, the method can be used to form a thermoplastic panel that includes the decorative objects 130 positioned within the fused thermoplastic resin material 210 in a manner that can create an aesthetic impression of a wave or a rippled surface within the thermoplastic panel 200. Thus, one or more implementations include three-dimensional and/or substantially two-dimensional objects in orientations or configurations not easy produced with conventional manufacturing processes using sheets or casting processes.

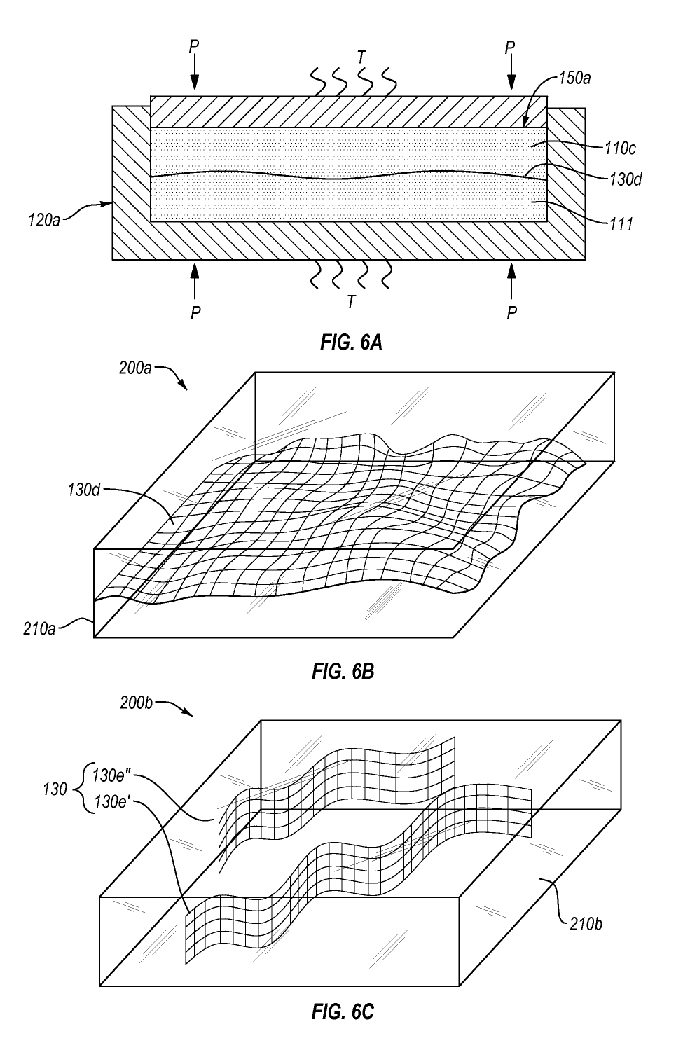

For example, as illustrated in FIG. 6A, the manufacturer can position a flexible decorative object 130d (e.g., fabric or sheet-like objects) within a bed 110c of thermoplastic resin particles 111, to form a layup assembly 150a. Generally, sheet-like decorative objects 130d can have two opposing major surfaces that define the length and width of such objects. A distance that defines the thickness of sheet-like decorative object 130d may separate the opposing major surfaces from each other. Furthermore, the length and width of sheet-like decorative objects 130d can be substantially greater than the thickness thereof.

It should be noted that the layup assembly 150a as well as the thermoplastic panel produced therefrom can be substantially the same as the layup assembly 150 (FIGS. 1-4) and the respective thermoplastic panel 200 (FIG. 5) produced from such layup assembly, except as otherwise described herein. In one or more implementations, the decorative object 130d can have a flowing or non-flat configuration, which can vary along the Z axis. The manufacturer can place the layup assembly 150a into a containment cell 120a. As described above, a plate or platen can fit within a containment window of the containment cell 120a and can apply pressure P to the layup assembly 150a.

In any case, as illustrated in FIG. 6B, after heating, melting, compressing, and/or fusing the thermoplastic resin particles 111, the manufacturer can produce a thermoplastic panel 200a. More specifically, the thermoplastic panel 200a can include the flexible decorative object 130d encased or encapsulated (e.g., monolithically encapsulated) within the fused thermoplastic resin material 210a. As noted above, the fused thermoplastic resin material 210a can encapsulate the decorative object 130d in a predetermined position. It should be also appreciated that the thermoplastic panel 200a can incorporate any number of flexible and/or sheet-like decorative objects 130d, which can reside within the fused thermoplastic resin material 210a.

The decorative objects 130d can include but are not limited to fabric, ribbons, foil, netting, mesh, and other flexible and semi-flexible sheet-like materials. Furthermore, the decorative objects 130d can be partially transparent or translucent (e.g., the decorative objects 130d can be sufficiently thin to allow light to pass therethrough). Hence, the thermoplastic panel 200a can be at least partially transparent or translucent, while incorporating decorative objects 130d that can be visible within the fused thermoplastic resin material 210a.

Whether incorporating a single or multiple decorative objects 130d, the flowing or non-flat, substantially two-dimensional decorative objects 130d can provide unique three-dimensional appearance. Furthermore, in light of this disclosure, those skilled in the art should appreciate that orientation of the decorative objects 130d within the fused thermoplastic resin material 210a can vary from one implementation to the next. For instance, as illustrated in FIG. 6C, a thermoplastic panel 200b can include other flexible and/or sheet-like decorative objects 130e (e.g., decorative objects 130e′, 130e″) encased within a fused thermoplastic resin material 210b. Except as otherwise described herein, the thermoplastic panel 200b as well as the decorative objects 130e can be similar to or the same as the thermoplastic panel 200a and the decorative objects 130d, respectively.

In one implementation, the decorative objects 130e can extend at a non-parallel angle to the final outer major surfaces of a finished thermoplastic panel 200b. In other words, major surfaces of the sheet-like decorative objects 130e can have a non-parallel angle relative to the outer major surfaces of the thermoplastic panel 200b. For instance, one or more of the decorative objects 130e can form an approximately 90° angle relative to the major outer surface of thermoplastic panel 200b.

In one or more other implementation, the decorative objects 130e can form essentially any angle with respect to the major outer surface of thermoplastic panel 200b (e.g., ribbons placed on their side can be at a 45° angle). Furthermore, decorative objects 130e also can be located at different angles relative to each other. For example, the decorative object 130e′ can be at a 90° angle and the decorative object 130e″ can be at a 45° angle relative to the major outer surface of thermoplastic panel 200b. Similar to the decorative objects 130f (FIG. 6B), the decorative objects 130e can have non-flat or flowing configuration within the fused thermoplastic resin material 210b.

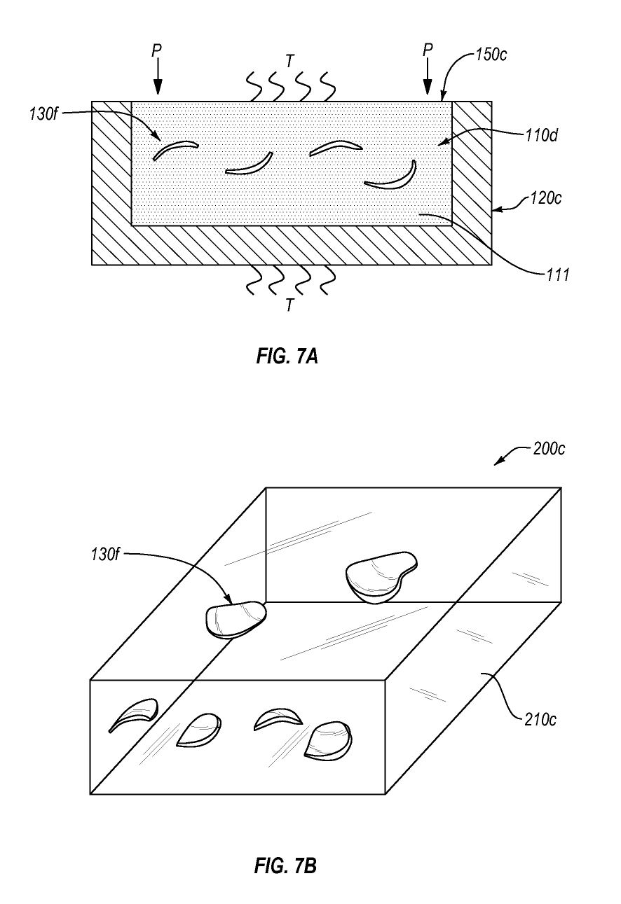

Additionally, as mentioned above, the thermoplastic panels can incorporate hollow or cored-out decorative objects. For example, as illustrated in FIG. 7A, the manufacturer can form a layup assembly 150c that can incorporate hollow, cored-out, or similar decorative objects 130f, which can have various voids and/or cavities therein. Except as otherwise described herein, the layup assembly 150c as well as any thermoplastic panel produced therefrom can be substantially the same as the layup assemblies 150, 150a (FIGS. 1-4, 6A) and respective thermoplastic panels 200, 200a, 200b (FIGS. 5, 6B, 6C) produced from such layup assemblies. For instance, the decorative objects 130f can be shells, honeycomb structures, etc. Such decorative objects 130f may be positioned within a bed or block 110d of thermoplastic resin particles 111, which together can form the layup assembly 150c.

In at least one implementation of the method, the thermoplastic resin particles 111 may fill vacant spaces within the hollow or cored-out decorative objects 130f. As described above, heat and pressure may compress, melt, and fuse the thermoplastic resin particles 111 into the fused thermoplastic resin material, thereby forming the thermoplastic panel 200c shown in FIG. 7B.

Furthermore, in some instances, the hollow and/or cored-out decorative objects 130f may be brittle, soft, or otherwise fragile and susceptible to damage under pressure. In at least one implementation, as the thermoplastic resin particles 111 can fill the vacant spaces within the hollow or cored-out decorative objects 130f. Hence, the thermoplastic resin particles 111 may provide reinforcement for the decorative objects 130f. Such reinforcement can prevent damaging, deforming, and/or breaking the decorative objects 130f when the pressure is applied to the layup assembly 150c.

In any case, after heating, melting, compressing, and/or fusing together the thermoplastic resin particles around the decorative objects 130f, the manufacturer can form a thermoplastic panel 200c, illustrated in FIG. 7B. Specifically, in one or more implementations, the thermoplastic panel 200b may have hollow or cored-out decorative objects 130f completely encased (i.e., including the previously-vacant spaces within the decorative objects 1300 within a fused thermoplastic resin material 210c. Moreover, as mentioned above, the fused thermoplastic resin material 210c can be at least partially transparent. Accordingly, substantially all portions of the decorative objects 130f (including the cored-out portions) can be visible in the thermoplastic panel 200c.

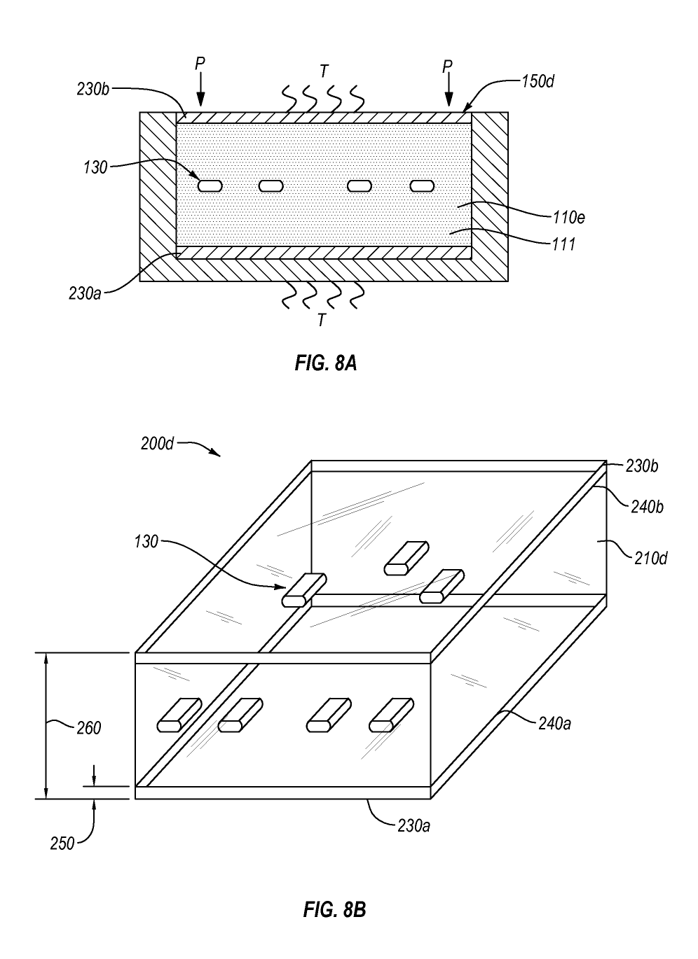

In one or more implementations, the method also may be used to form multilayer thermoplastic panels. Such method may include forming a layup assembly 150d that has decorative objects 130 placed within a bed or block 110e of thermoplastic resin particles 111, as illustrated in FIG. 8A. Except as otherwise described herein, the layup assembly 150d as well as any thermoplastic panel produced therefrom can be substantially the same as any of the layup assemblies 150, 150a, 150c (FIGS. 1-4, 6A, 7A) and respective thermoplastic panels 200, 200a, 200b, 200c (FIGS. 5, 6B, 7B) produced from such layup assemblies. For instance, the layup assembly 150d can include first and second sheets (or sheet layers) 230a, 230b positioned about the bed or block 110e of thermoplastic resin particles 111. In other words, the manufacturer can place the bed or block 110e of thermoplastic resin particles 111 together with the decorative objects 130 embedded therein between the first and second sheets 230a, 230b.

One or more implementations may include using the first and second sheets 230a, 230b made from materials dissimilar to the thermoplastic resin particles 111 of the bed or block 110e. For example, the first and/or second sheets 230a, 230b may be glass, wood, or metal. Heat and pressure may be applied to the layup assembly 150d to melt and fuse the thermoplastic resin particles 111 into a fused thermoplastic resin material and to couple the first and/or second sheets 230a, 230b to the fused thermoplastic resin material, thereby forming the multilayer thermoplastic panel.

Particularly, after heating, melting, pressing, and fusing together the thermoplastic resin particles about the decorative objects, the manufacturer can form a multilayer thermoplastic panel 200d, as illustrated in FIG. 8B. More specifically, the multilayer thermoplastic panel 200d can have a single or multiple decorative objects 130 encased and a fused thermoplastic resin material 210d. Particularly, the first and second sheets 230a, 230b can be fused to the major outer surfaces of the thermoplastic resin material 210d. Accordingly, the first and second sheets 230a, 230b can form the major outer surfaces of the multilayer thermoplastic panel 200d.

In one or more implementations the first and/or second sheets 230a, 230b can be substantially transparent or translucent. Thus, the decorative objects 130 can be at least partially visible through the first and/or second sheets 230a, 230b. Alternatively, the first and/or second sheets 230a, 230b can comprise a substantially opaque material. Hence, in at least one implementation, the decorative objects 130 may be at least partially concealed by the first and/or second sheets 230a, 230b.

Moreover, the multilayer thermoplastic panel 200d can have first and second sheet 230a, 230b that comprise materials dissimilar to the thermoplastic resin particles that formed fused thermoplastic resin material 210d. Thus, the first and/or second sheets 230a, 230b may be distinctly identifiable by respective fuse lines 240a, 240b, which may be formed between the first and second sheets 230a, 230b and the fused thermoplastic resin material 210c. For example, the first and/or second sheets 230a, 230b may be metal or glass.

Alternatively, however, the multilayer thermoplastic panel 200d may include the first and second sheets 230a, 230b that comprise the same or similar material as the thermoplastic resin particles that formed the fused thermoplastic resin material 210d. Consequently, after applying heat and pressure to the layup assembly, the multilayer thermoplastic panel 200d may have no visible distinction between the first and/or second sheets 230a, 230b and the fused thermoplastic resin material 210d. In other words the thermoplastic panel 200d can appear substantially the same as the thermoplastic panel 200 (FIG. 5).

The first and second sheets 230a, 230b can have a thickness 250, which can vary from one implementation to another. Hence, in one or more implementations, the multilayer thermoplastic panel 200d can be thicker than the thermoplastic panel 200 (FIG. 5). The multilayer thermoplastic panel 200d may have a thickness 260, which may be in the range of approximately between 0.13″ to 2.00″ (3.2 mm to 51 mm).

In some instances, the thickness 260 includes first and second sheets 230a, 230b. Additionally or alternatively, the method may be used to form the thermoplastic panel 200c that has non-uniform thickness 260, which may vary along the X and/or Y axes. Moreover, in at least one implementation, the thermoplastic panel 200d may be thicker than 2.00″ or thinner than 0.13″.

The methods described herein also can be used to generally preserve objects from aging and natural deterioration. Furthermore, the panels produced using the method disclosed herein can preserve the integrity of the decorative objects that could otherwise be damaged, ruined, or disfigured using conventional thermoforming processes. For instance, the fused thermoplastic block and/or the surrounding sheets may include UV coating, which can aid in preserving the decorative objects within the thermoplastic panel. The methods and apparatus described herein can permit incorporating hollow and fragile decorative objects 130, which have highly desirable aesthetic properties but heretofore have been impractical or impossible to incorporate into thermoplastic panels.

The use of thermoplastic resin particles can provide many advantages, configurations, and versatility in forming panels with decorative objects embedded therein not available when using conventional methods. One will appreciate in light of the disclosure herein that the present invention is not limited to the formation of panels with decorative objects. Indeed implementations of the present invention include methods of forming panels using thermoplastic resin particles that do not include decorative objects.

For example, one or more implementations of the present invention include using thermoplastic resin particles to form panels having embossing or otherwise recessed designs in one or more of the surfaces. In particular, a mold(s) can be pressed into a layer of thermoplastic resin particles. The mold can displace the particles such that after the application of heat and pressure, a pattern in the mold is formed in the resultant resin panel.

The use of thermoplastic particles also can allow embossing of extreme depth and other embossing textures possible. Conventionally, fabricating a thermoplastic panel with a very deep embossment, high pressure may exist at the lowest points of the pattern, which may have a tendency to “push” through to the other (flat surface) of the resin sheet. With the thermoplastic resin particles can facilitate substantially uniform pressure even with complex textures.

Thus, the use of thermoplastic resin particles can allow deep embossing without disrupting a surface opposite of the embossing. As used herein deep embossing refers to embossments that extend to a depth of at least about 25% or more of the gauge of the panel. The use of thermoplastic resin panels also can allow the manufacturer to create embossed patterns with undercuts (using complex part molds), which ordinarily may not be possible (as the resin of the sheets may not easily flow into undercutting portions of a mold).

Thus, thermoplastic panels described herein can be economically produced and may be substantially flat, curved, or shaped (e.g., formations with compound or irregular curvatures). Flat thermoplastic panels may be sold to customers in standard sizes determined by the manufacturer, or in custom sizes ordered by the purchaser. Typical sizes made available to or desired by customers may vary between large 5′×10′ sheets down to 6″×6″ tiles. During the manufacturing process, the laminate sheets may be formed larger than the standard or customer-defined sizes that are eventually sold. This can be due to the size of the manufacturing equipment used to create the laminate sheets, or because of a desire to trim the excess material in order to create a clean edge on the final product (i.e., creating straight, rectangular panels).

One will also appreciate in light of the disclosure herein that, because the bed or block can contain numerous thermoplastic resin particles, which allow placement of the decorative objects at essentially any location therein, the manufacturer can fabricate thermoplastic panels that can have numerous configurations. More specifically, the thermoplastic panels fabricated using the method described herein can incorporate decorative objects at numerous orientations or configurations. By contrast, typical for thermoplastic panel fabricated from resin sheets embody flat configurations of decorative objects.

Additionally, thermoplastic resin particles can hold decorative objects in place throughout the manufacturing process. This is in contrast to conventional liquid casting or lamination in which the decorative objects or interlayers often move may not be in the same position/orientation in which originally laid out. In a casting process, objects of substantially different densities to that of the casting resin will float or sink, and therefore change from their original positioning. The implementations of the present invention, however, allows the manufacturer to fabricate thermoplastic panels that incorporate various decorative objects located at predetermined positions within the fused thermoplastic resin material of the thermoplastic panel. Thus, implementations of the present invention allow great versatility and almost limitless positions/orientations of decorative objects within a resin panel.

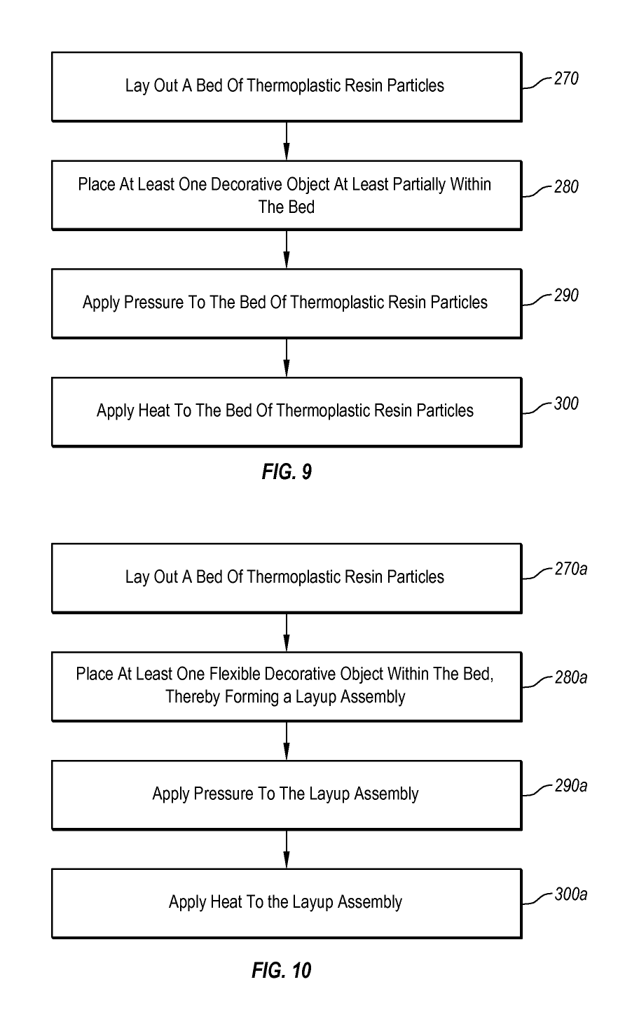

Accordingly, FIGS. 1-8B and the corresponding text, provide a number of different components and mechanisms for fabricating thermoplastic panels, which can encapsulate decorative objects. In addition to the foregoing, embodiments also can be described in terms one or more acts in a method for accomplishing a particular result. Particularly, FIGS. 9 and 10 illustrates methods of manufacturing a decorative thermoplastic panel. The acts of FIGS. 9 and 10 are described below with reference to the components and diagrams of FIGS. 1 through 8B.

For example, FIG. 9 shows that, in one implementation, the method can include an act 270 of laying out a bed or block 110, 110c, 110d, 110e of thermoplastic resin particles 111. As described above, the thermoplastic resin particles 111 can be uniform or non-uniform and can comprise any number of suitable thermoplastic materials.

The method also can include an act 280 of placing at least one decorative object 130, 130d, 130e, 130f at least partially within the bed or block 110, 110c, 110d, 110e of thermoplastic resin particles 111. Furthermore, the decorative objects 130, 130d, 130e, 130f can be placed at essentially any location and at any orientation within the bed or block 110, 110c, 110d, 110e of thermoplastic resin particles 111. Accordingly, the manufacturer can fabricate a thermoplastic panel having any number of designs and/or configurations of decorative objects 130, 130d, 130e, 130f that form one or more interlayers thereof.

It should be appreciated that acts described herein can be performed in any number of sequences. Moreover, an act can be only partially completed before commencement of another act. For instance, the manufacturer can form a portion of the bed or block 110, 110c, 110d, 110e of thermoplastic resin particles 111 (e.g., by forming the first layer 110a). Subsequently, the manufacturer can place the decorative objects 130, 130d, 130e, 130f on the portion of the bed or block 110, 110c, 110d, 110e of thermoplastic resin particles 111 and complete forming the bed or block by adding thermoplastic resin particles 111 on top of the formed portion of the bed or block 110. Alternatively, the manufacturer can form the bed or block 110, 110c, 110d, 110e of thermoplastic resin particles 111 and, subsequently, position the decorative objects 130, 130d, 130e, 130f therein.

The method also can include an act 290 of applying pressure to the bed or block 110, 110c, 110d, 110e of thermoplastic resin particles 111, which can contain the decorative objects 130, 130d, 130e, 130f Furthermore, the method can include an act 300 of applying heat to the bed or block 110, 110c, 110d, 110e of thermoplastic resin particles 111, which can contain the decorative objects 130, 130d, 130e, 130f. In light of this disclosure, those skilled in the art should appreciate that, as noted above, the manufacturer can perform acts 290 and 300 in any sequence (e.g., simultaneously).

In at least one implementation, the manufacturer can place the bed or block 110, 110c, 110d, 110e of thermoplastic resin particles 111, which contains the decorative objects 130, 130d, 130e, 130f, into a heated mechanical press, autoclave, or other thermosetting environment. As the thermosetting environment heats and compresses the bed or block 110, 110c, 110d, 110e of thermoplastic resin particles can at least partially melt and fuse together. Thus, after cooling below the glass transition temperature, the bed or block 110, 110c, 110d, 110e of thermoplastic resin particles 111 can form the fused thermoplastic resin material 210, 210a, 210b, 210c, 210d of the thermoplastic panel 200, 200a, 200b, 200c, 200d.

Furthermore, as noted above, the decorative objects 130, 130d, 130e, 130f together with the fused thermoplastic resin material 210, 210a, 210b, 210c, 210d, can form thermoplastic panels 200, 200a, 200b, 200c, 210d. In at least one implementation, the first and/or second sheets 230a, 230b can be fused to the fused thermoplastic resin material 210d. Accordingly, the first and/or second sheets 230a, 230b together with the thermoplastic resin material 210 can form the multilayer thermoplastic panel 200d.

As illustrated in FIG. 10, in at least one implementation, the method can include an act 280a of laying out the bed or block 110, 110c, 110d, 110e of thermoplastic resin particles 111, thereby forming the layup assembly 150, 150a, 150c, 150d. Examples of the flexible decorative object 130, 130d, 130e, 130f include but are not limited to fabric, foil, ribbon, or any sheet-like object. Moreover, the decorative object 130, 130d, 130e, 130f can have any number of configurations (e.g., flat, non-flat, bent, twisted, etc.)

As described above, the manufacturer can place such decorative objects 130, 130d, 130e, 130f essentially anywhere within the bed or block 110, 110c, 110d, 110e of thermoplastic resin particles 111. Furthermore, any portion of the flexible decorative object 130, 130d, 130e, 130f can reside essentially anywhere within the bed or block 110, 110c, 110d, 110e of thermoplastic resin particles 111. For example, decorative objects 130, 130d, 130e, 130f can reside on different X-Y planes relative to one another. Additionally, the flexible decorative objects 130, 130d, 130e, 130f can be bent, folded, twisted, or can have any other non-flat configuration within the bed or block 110, 110c, 110d, 110e of thermoplastic resin particles 111.

The method also can include an act 290a of applying pressure to the layup assembly 150, 150a, 150c, 150d and an act 300a of applying heat to the layup assembly 150, 150a, 150c, 150d. As noted above, the manufacturer can perform such acts simultaneously or at other sequences. In any event, after heating and compressing the layup assembly 150, 150a, 150c, 150d, the thermoplastic resin particles 111 of the bed or block 110, 110c, 110d, 110e can fuse together and about the decorative objects 130, 130d, 130e, 130f, thereby forming the fused thermoplastic resin material 210, 210a, 210b, 210c, 210d.

The fused thermoplastic resin material 210, 210a, 210b, 210c, 210d together with the decorative objects 130, 130d, 130e, 130f can comprise the thermoplastic panel 200, 200a, 200b, 200c, 200d. Moreover, the thermoplastic panel 200, 200a, 200b, 200c, 200d can include flexible decorative objects 130, 130d, 130e, 130f positioned at various angles relative to the major surfaces of the thermoplastic panel 200, 200a, 200b, 200c, 200d. Also, the flexible decorative objects 130, 130d, 130e, 130f can be bent, folded, twisted, or can have any non-flat configuration within the fused thermoplastic resin material 210, 210a, 210b, 210c, 210d of the thermoplastic panel 200, 200a, 200b, 200c, 200d.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of manufacturing a decorative thermoplastic panel that incorporates decorative objects, the method comprising:
laying out a bed of thermoplastic resin particles;
placing at least one decorative object at least partially within the bed of thermoplastic resin particles;
applying pressure to the bed of thermoplastic resin particles containing the at least one decorative object; and
applying heat to the bed of thermoplastic resin particles containing the at least one decorative object, thereby fusing the thermoplastic resin particles together about the at least one decorative object.

2. The method as recited in claim 1, wherein the bed of thermoplastic resin particles has a first major surface.

3. The method as recited in claim 2, wherein the at least one decorative object has at least one major surface that has a substantially parallel orientation with the first major surface of the bed of thermoplastic resin particles.

4. The method as recited in claim 2, wherein the at least one decorative object has at least one major surface that has a substantially non-parallel orientation with the first major surface of the bed of thermoplastic resin particles.

5. The method as recited in claim 2, wherein:
at least one decorative object comprises a plurality of decorative objects; and
two or more decorative objects of the plurality of decorative objects are placed on different two-dimensional planes that are parallel to the first major surface.

6. The method as recited in claim 1, wherein the at least one decorative object has one or more cavities therein, and the thermoplastic resin particles at least partially fill the one or more cavities of the decorative object.

7. The method as recited in claim 1, further comprising positioning one or more of a first sheet and a second sheet about the bed of thermoplastic resin particles.

8. The method as recited in claim 7, wherein the bed of thermoplastic resin particles comprises a first material and one or more of the first sheet and the second sheet comprise a second material different than the first material.

9. The method as recited in claim 1, wherein the bed of thermoplastic resin particles comprises thermoplastic resin particles having at least one dimension in the range of approximately 0.01 inches to 0.1 inches.

10. The method as recited in claim 9, wherein the bed of thermoplastic resin particles comprises between approximately at least 100 thermoplastic resin particles.

11. A method of manufacturing a decorative thermoplastic panel that incorporates decorative objects, the method comprising:
laying out a bed of thermoplastic resin particles having a first dimension defined by a length thereof, a second dimension defined by a width thereof, and a third dimension defined by a thickness thereof, the first, second, and third dimensions defining a plurality of two-dimensional planes;
placing at least one flexible decorative object within the bed of thermoplastic resin particles in a manner that at least a portion of the at least one flexible decorative object is in two or more two-dimensional planes of the plurality of two-dimensional planes, and wherein the bed of thermoplastic resin particles together with the at least one flexible decorative object form a layup assembly;
applying pressure to the layup assembly; and
applying heat to the layup assembly, thereby fusing the thermoplastic resin particles together about the at least one flexible decorative object.

12. The method as recited in claim 11, wherein the at least one flexible decorative object has opposing major surfaces separated by a distance that defines a thickness of the at least one flexible decorative object.

13. The method as recited in claim 12, wherein the at least one flexible decorative object has a non-flat configuration.

14. The method as recited in claim 11, wherein the at least on flexible decorative object has one or more of a bent and twisted configuration.

15. The method as recited in claim 11, wherein the first and second dimensions are substantially greater than the third dimension of the bed of thermoplastic resin particles.

16. A decorative thermoplastic resin panel with a sheet-like three-dimensional decorative interlayer, the decorative thermoplastic resin panel comprising:
a fused thermoplastic block having a first dimension defined by a length thereof, a second dimension defined by a width thereof, and a third dimension defined by a thickness thereof, the first, second, and third dimensions defining a plurality of two-dimensional planes; and
at least one flexible decorative object encapsulated within the fused thermoplastic block, wherein the at least a portion of the at least one flexible decorative object is positioned in two or more two-dimensional planes of the plurality of two-dimensional planes.

17. The decorative thermoplastic panel as recited in claim 16, wherein the at least one flexible decorative object is encapsulated at a predetermined position within the fused thermoplastic block.

18. The decorative thermoplastic panel as recited in claim 16, wherein the at least one flexible decorative object has a non-flat configuration.

19. The decorative thermoplastic panel as recited in claim 16, wherein the at least one flexible decorative object has two opposing major surfaces separated by a distance that defines a thickness of the at least one flexible decorative object.

20. The decorative thermoplastic panel as recited in claim 16, wherein the fused thermoplastic block has a first major surface defined by the first and second dimensions, and at least one of the opposing major surfaces of the at least one flexible decorative object is oriented at a non-parallel angle relative to the major surface of the fused thermoplastic block.
